(19) United States
(12) Patent Application Publication
(10) Pub. No.: US 2025/0239808 A1
(43) Pub. Date: Jul. 24, 2025

(54) CONNECTOR

(71) Applicant: SUMITOMO WIRING SYSTEMS, LTD., Mie (JP)

(72) Inventor: Yuya SHINKAWA, Mie (JP)

(21) Appl. No.: 19/021,899

(22) Filed: Jan. 15, 2025

(30) Foreign Application Priority Data
Jan. 24, 2024 (JP) 2024-008625

(51) Int. Cl. H01R 13/627

(52) U.S. Cl. CPC H01R 13/6272

(57) ABSTRACT

A connector 10 includes a first connector 20 and a second connector 60 connectable to each other. The first connector 20 includes a lock arm 28 extending in a front-rear direction and resiliently deformable in a direction intersecting the front-rear direction with a front end part 31 as a fulcrum. The second connector 60 includes a lock portion 67 to be locked to the lock arm 28 and a contact portion 73 located behind the lock portion 67 for contacting a rear end part 34 of the lock arm 28 resiliently deformed in the process of connecting the first and second connectors 20, 60 and suppressing a displacement of the rear end part 34 in a resilient deformation direction of the lock arm.

### CROSS-REFERENCE TO RELATED APPLICATIONS

This application is based on and claims priority from Japanese Patent Application No. 2024-008625, filed on Jan. 24, 2024, with the Japan Patent Office, the disclosure of which is incorporated herein in its entirety by reference.

### TECHNICAL FIELD

The present disclosure relates to a connector.

### BACKGROUND

Japanese Patent Laid-open Publication No. 2016-201259 discloses a connector and a mating connector connectable (joinable) to each other. The connector includes a housing body capable of accommodating a terminal and a lock arm projecting from the housing body and extending rearward (direction opposite to a connection direction of the connector to the mating connector). The lock arm is resiliently deformed with a coupling portion coupled to the housing body as a fulcrum in the process of connecting the connector, and resiliently returns to be locked to a locking claw of the mating connector when the connection is completed.

### SUMMARY

To obtain a so-called lock feeling of recognizing locking due to the resilient return of the lock arm when the connection of the connector and the mating connector is completed, it is desired to take a large deflection amount of the lock arm and increase a resilient returning speed of the lock arm. For example, in Japanese Patent Laid-open Publication No. 2016-201259, a lock feeling can be improved by adjusting a resilient force of a lock arm, such as by changing the shape of the lock arm from a cantilever shape to a beam shape supported on both ends. However, if the lock arm has the beam shape supported on both ends in Japanese Patent Laid-open Publication No. 2016-201259, the connection resistance of the connector increases and there is a concern that workability during connector connection is deteriorated. Further, there is also a situation where the shape of a female housing including an existing lock arm cannot be changed.

Accordingly, the present disclosure aims to provide a connector capable of improving a lock feeling by increasing a reaction force of a lock arm during connection.

The present disclosure is directed to a connector with a first connector and a second connector connectable to each other, when a connection direction of the first connector to the second connector is a forward direction and an opposite direction thereof is a rearward direction, the first connector including a lock arm extending in a front-rear direction, the lock arm being resiliently deformable in a direction intersecting the front-rear direction with a front end part as a fulcrum, and the second connector including a lock portion to be locked to the lock arm and a contact portion located behind the lock portion for contacting a rear end part of the lock arm resiliently deformed in the process of connecting the first and second connectors and suppressing a displacement of the rear end part in a resilient deformation direction of the lock arm from a contact position.

According to the present disclosure, it is possible to provide a connector capable of improving a lock feeling by increasing a reaction force of a lock arm during connection.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side view in section enlargedly showing a state where a rear end part of a lock arm contacts a contact portion in the process of connecting a first connector and a second connector in a connector of one embodiment.

FIG. 2 is a side view in section showing a state where the first connector and the second connector are connected in the connector of the embodiment.

FIG. 3 is a back view enlargedly showing the structures of upper end sides of the first and second connectors in a connected state in the connector of the embodiment.

FIG. 4 is a perspective view of a first housing in the connector of the embodiment when viewed obliquely from a front upper side.

FIG. 5 is a plan view of the first housing in the connector of the embodiment.

FIG. 6 is a perspective view of a second housing in the connector of the embodiment when viewed obliquely from a rear upper side.

FIG. 7 is a back view of the second housing in the connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

(1) The connector of the present disclosure is provided with a first connector and a second connector connectable to each other, when a connection direction of the first connector to the second connector is a forward direction and an opposite direction thereof is a rearward direction, the first connector including a lock arm extending in a front-rear direction, the lock arm being resiliently deformable in a direction intersecting the front-rear direction with a front end part as a fulcrum, and the second connector including a lock portion to be locked to the lock arm and a contact portion located behind the lock portion for contacting a rear end part of the lock arm resiliently deformed in the process of connecting the first and second connectors and suppressing a displacement of the rear end part in a resilient deformation direction of the lock arm from a contact position.

In the process of connecting the first and second connectors, the contact portion of the second connector contacts the rear end part of the lock arm to suppress a displacement of the rear end part of the lock arm, whereby the lock arm can be resiliently deformed in a state substantially supported on both ends at the contact portion and the front end part. Thus, a reaction force of the lock arm can be increased when the connection of the first and second connectors is completed, and a lock feeding can be improved.

Since the lock arm is cantilevered and resiliently deformed with the front end part as a fulcrum until the contact portion of the second connector contacts the rear end part of the lock arm in the process of connecting the first and second connectors, an increase in the connection resistance of the first connector can be avoided. Further, since the contact portion is included in the second connector, the design of the shape of the first connector including the lock arm needs not be changed.

(2) Preferably, in the connector of (1) described above, the first connector includes a housing body for accommodating a first terminal fitting, the front end part of the lock arm is coupled to a front end side of the housing body and the rear end part of the lock arm is located behind the housing body.

According to the configuration of (2) described above, since the entire length of the lock arm can be made longer as compared to the case where the rear end part of the lock arm is located within a formation range of the housing body in the front-rear direction, a large resilient deformation amount of the lock arm (resilient deformation amount in a vertical direction in the case of an embodiment to be described later) can be ensured while the housing body is reduced in size. As a result, the lock feeling can be further improved. Particularly, since the housing body cannot contact the rear end part of the lock arm in the case of the configuration of (2) described above, a merit of forming the contact portion in the second connector is large.

(3) Preferably, in the connector of (1) or (2) described above, the second connector includes a fitting portion to be fit to the housing body, the lock portion is formed on the fitting portion, the contact portion is located behind the fitting portion, the second connector includes wall-like projecting portions projecting rearward from the fitting portion and arranged in pair in a width direction intersecting both the resilient deformation direction of the lock arm and the front-rear direction, and the projecting portions arranged in pair are located on both sides in the width direction of the contact portion.

Even if the contact portion projects rearward from the fitting portion, the contact portion is structured to be hardly interfered with by foreign matters trying to intrude from both widthwise sides since the projecting portions are located on the both widthwise sides of the contact portion. Note that the resilient deformation direction of the lock arm is equivalent to the vertical direction in the case of the embodiment.

(4) In the connector of (3) described above, the contact portion may be integrally coupled to each of the projecting portions arranged in pair.

Since the contact portion is coupled to each of the paired projecting portions, the rigidity of the contact portion can be enhanced.

### DETAILS OF EMBODIMENT OF PRESENT DISCLOSURE

A specific example of the present disclosure is described below with reference to the drawings. Note that the present invention is not limited to this illustration, but is represented by claims and intended to include all changes in the scope of claims and in the meaning and scope of equivalents.

### Embodiment

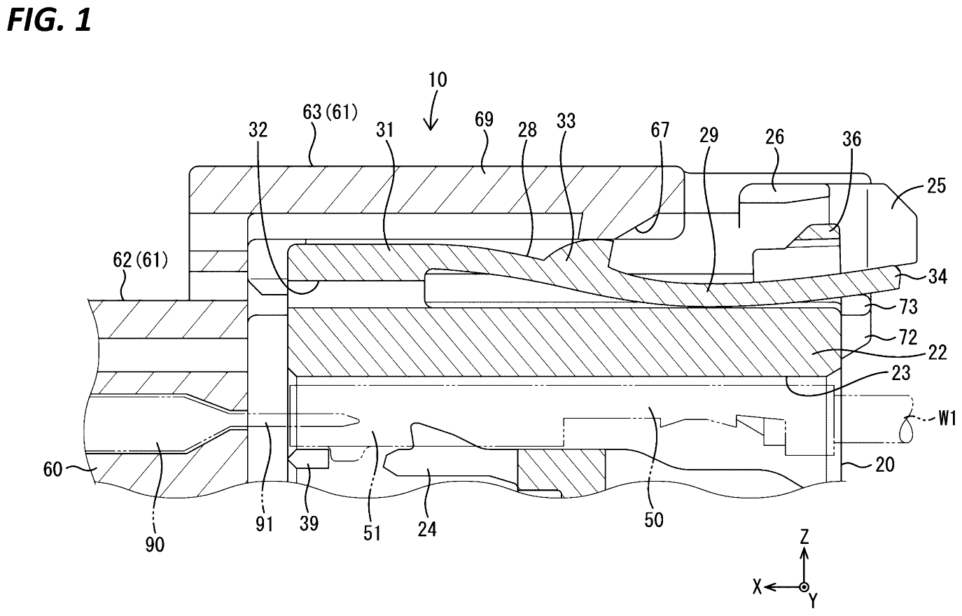

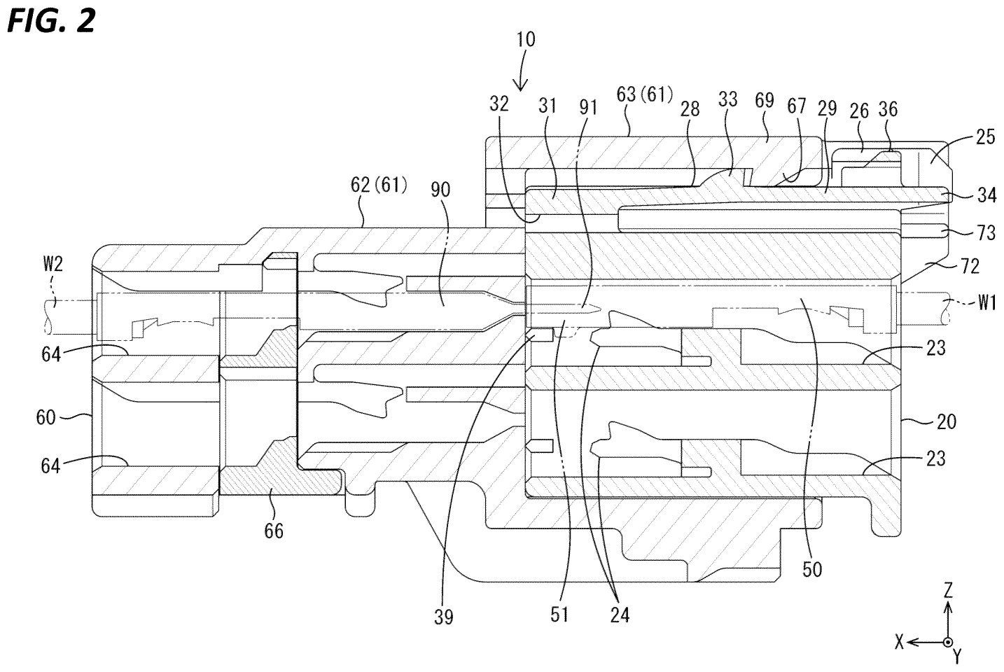

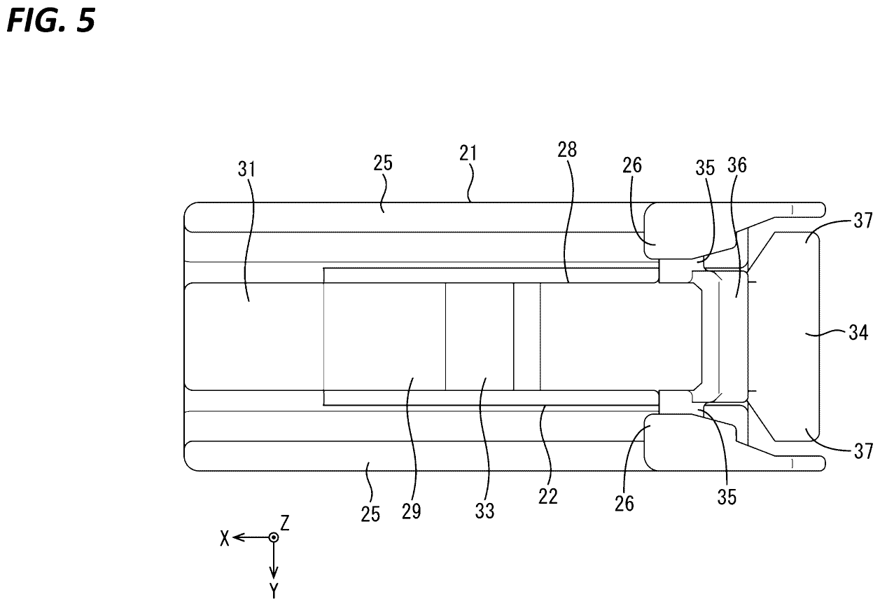

A connector 10 of one embodiment is, as shown in FIGS. 1 and 2, provided with a first connector 20 and a second connector 60 connectable to each other. Note that, in the following description, a connection direction of the first connector 20 to the second connector 60 is a forward direction and an opposite direction thereof is a rearward direction concerning a front-rear direction. A vertical direction is based on a vertical direction of each figure except FIG. 5. The vertical direction is synonymous with a height direction. A lateral direction is based on a lateral direction when viewed from front. The lateral direction is synonymous with a width direction. In each figure, X represents a front side, Y represents a right side and Z represents an upper side. These direction references do not necessarily coincide with direction references in a state where the connector 10 is installed in an unillustrated vehicle or the like.

### (First Connector 20)

The first connector 20 includes a first housing 21 made of synthetic resin and first terminal fittings 50 made of electrically conductive metal. As shown in FIG. 2, the first terminal fitting 50 is a so-called female terminal and includes a tubular box portion 51 on a front end side. A tab 91 of a second terminal fitting 90 to be described later is inserted into the box portion 51. The tab 91 contacts an unillustrated resilient contact portion in the box portion 51, whereby the first terminal fitting 50 and the second terminal fitting 90 are electrically connected. A rear end part of the first terminal fitting 50 is crimped and electrically and mechanically connected to an end part of a wire W1.

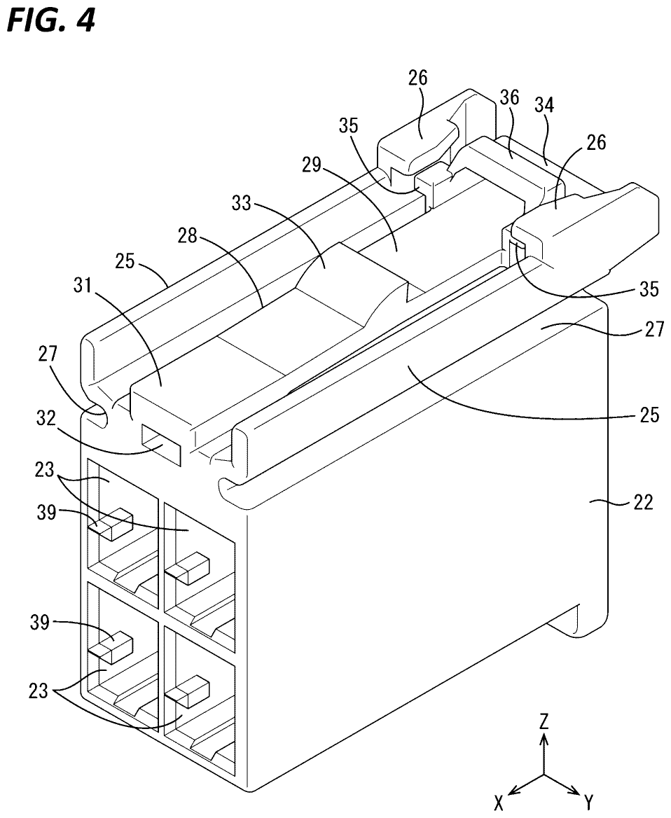

The first housing 21 includes a housing body 22 for accommodating the first terminal fittings 50. As shown in FIG. 4, the housing body 22 has a rectangular outer shape and includes a plurality of first cavities 23 penetrating in the front-rear direction. The respective first cavities 23 are arrayed and arranged in the width direction in each of upper and lower stages in the housing body 22. As shown in FIG. 2, a resiliently deformable first locking lance 24 is formed to project on the inner surface of each first cavity 23. The first terminal fitting 50 is inserted into the first cavity 23 from behind. The first terminal fitting 50 is restricted from coming out rearward from the first cavity 23 by being locked by the first locking lance 24. Further, the first terminal fitting 50 is also restricted from coming out forward from the first cavity 23 by contacting a stopper portion 39 projecting on the inner surface of the first cavity 23 from behind.

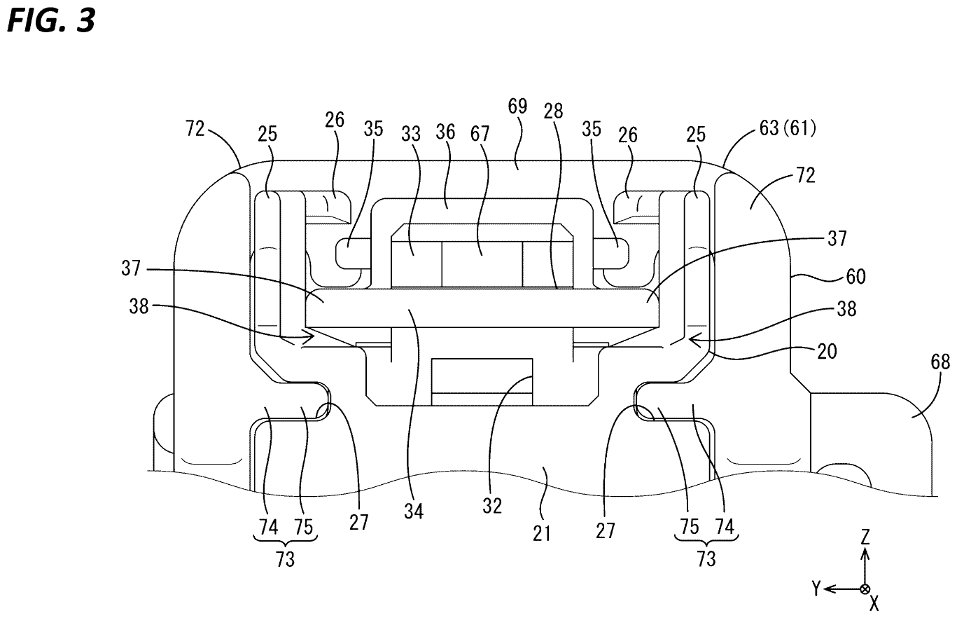

As shown in FIGS. 3 and 4, the first housing 21 includes a pair of side portions 25 rising from both left and right end parts of the upper surface of the housing body 22. As shown in FIGS. 4 and 5, each side portion 25 extends in the front-rear direction beyond a formation range (front-rear length) of the housing body 22. In the front-rear direction, the front end of each side portion 25 is at the same position as the front surface of the housing body 22, and the rear end thereof is located behind the rear surface of the housing body 22. That is, a rear end part of each side portion 25 projects further rearward than the rear surface of the housing body 22 in the front-rear direction.

As shown in FIG. 4, parts near the rear end parts of the respective side portions 25 include a pair of protruding portions 26 arranged to be higher than parts in front of and adjacent to these parts and protruding laterally inward (toward a lateral central side of the housing body 22) from these parts. As shown in FIG. 3, each protruding portion 26 is facing to be able to contact each protrusion 35 of a lock arm 28 to be described later from above.

As shown in FIG. 4, the first housing 21 includes a pair of left and right groove portions 27 extending in the front-rear direction and open forward and rearward between base end sides (lower end sides) of the respective side portions 25 and an upper surface side of the housing body 22. As shown in FIG. 3, later-described contact portions 73 of the second connector 60 are inserted into the respective groove portions 27 when the first and second connectors 20, 60 are connected.

As shown in FIGS. 4 and 5, the first housing 21 includes the lock arm 28 arranged above a lateral central part of the upper surface of the housing body 22. The lock arm 28 is in the form of a plate having plate surfaces facing in the vertical direction, and includes an arm body 29 extending in the front-rear direction.

As shown in FIG. 4, a front end part 31 of the lock arm 28 (arm body 29) is integrally coupled to the upper surface of the housing body 22. Further, the front end part 31 of the lock arm 28 is integrally coupled also to the respective side portions 25 on both left and right sides. The lock arm 28 is resiliently deformable in the vertical direction with the front end part 31 as a fulcrum. The front end part 31 of the lock arm 28 is formed with a through hole 32 penetrating in the front-rear direction. The through hole 32 has a rectangular opening shape long in the lateral direction. Ease of resilient deformation of the lock arm 28 is ensured by the through hole 32.

As shown in FIGS. 4 and 5, the lock arm 28 includes a lock projection 33 projecting from a central part in the front-rear direction on the upper surface of the arm body 29. As shown in FIGS. 2 and 3, the lock projection 33 is locked to a later-described lock portion 67 of the second connector 60 when the first and second connectors 20, 60 are connected.

As shown in FIG. 4, the lock arm 28 includes a pair of the protrusions 35 protruding laterally outward from a part of the arm body 29 near a rear end part 34 and projecting upward. As shown in FIG. 5, the respective protrusions 35 are arranged at positions overlapping the respective protruding portions 26 in the front-rear direction. The arm body 29 is resiliently deformed upward and the respective protrusions 35 butt against the respective protruding portions 26, whereby excessive upward resilient deformation of the lock arm 28 is suppressed. Further, as shown in FIGS. 4 and 5, the lock arm 28 includes a beam-like releasing portion 36 bridged between the respective protrusions 35. The releasing portion 36 is arranged above the upper surface of the arm body 29. In separating the first and second connectors 20, 60 in a connected state, the releasing portion 36 is pressed from above and the part of the arm body 29 near the rear end part 34 is pushed downward. Then, the lock projection 33 is separated from the lock portion 67, the locking of the lock arm 28 and the lock portion 67 is released and the first and second connectors 20, 60 become separable.

As shown in FIGS. 4 and 5, the lock arm 28 has a front-rear length exceeding the formation range of the housing body 22, similarly to each side portion 25. The rear end of the lock arm 28 is located behind the rear surface of the housing body 22. That is, the rear end part 34 of the lock arm 28 projects further rearward than the rear surface of the housing body 22 in the front-rear direction. As shown in FIG. 5, the rear end part 34 of the lock arm 28 includes a pair of expanded portions 37 protruding toward both left and right sides. The rear end part 34 of the lock arm 28 is expanded laterally outward and formed to be wider than an adjacent part (part located within the formation range of the housing body 22 in the front-rear direction) in front of the rear end part 34 by the respective expanded portions 37. The rear end part 34 of the lock arm 28 is located between the respective side portions 25 and covered from both left and right sides by rear end parts of the respective side portions 25. As shown in FIG. 3, deflection spaces 38 for the lock arm 28 are formed below the respective expanded portions 37, and tip parts 75 of the later-described contact portions 73 of the second connector 60 are arranged to enter the deflection spaces 38 when the first and second connectors 20, 60 are connected. As shown in FIG. 5, laterally outer ends of the respective expanded portions 37 are proximate to the facing side portions 25 while being spaced apart from the side portions 25.

### (Second Connector 60)

The second connector 60 includes a second housing 61 made of synthetic resin and second terminal fittings 90 made of electrically conductive metal. As shown in FIG. 2, the second terminal fitting 90 is a so-called male terminal and includes the tab 91 projecting rearward. A front end part of the second terminal fitting 90 is crimped and electrically and mechanically connected to an end part of a wire W2.

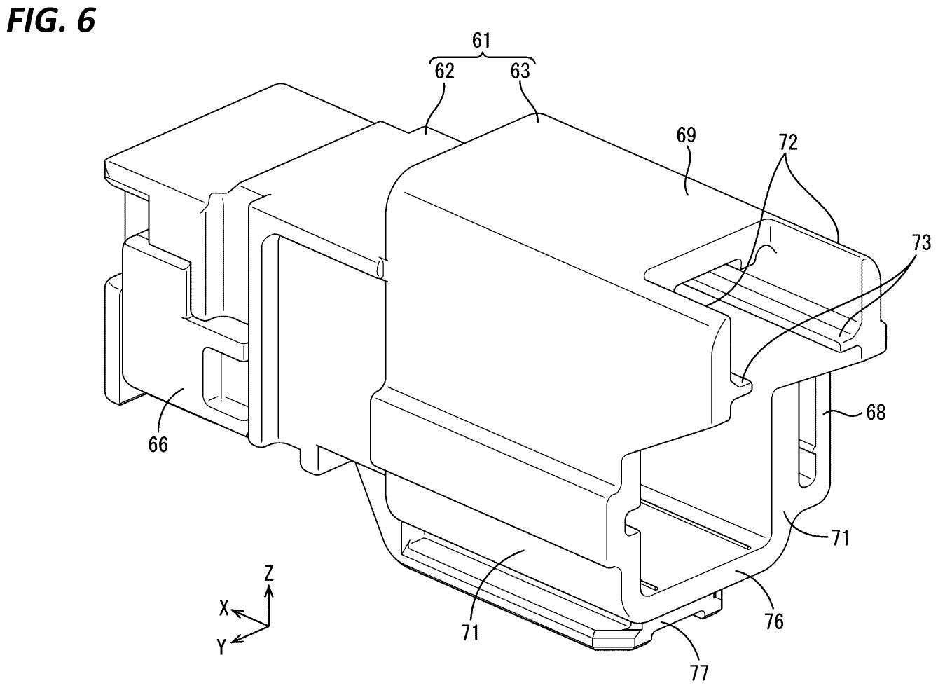

As shown in FIGS. 2 and 6, the second housing 61 includes a terminal accommodating portion 62 for accommodating the second terminal fittings 90 and a fitting portion 63 one size larger than the terminal accommodating portion 62 and projecting rearward.

As shown in FIG. 2, the terminal accommodating portion 62 includes a plurality of second cavities 64 penetrating in the front-rear direction. The respective second cavities 64 are arranged at positions corresponding to the respective first cavities 23 of the first housing 21. A resiliently deformable second locking lance 64 is formed to project on the inner surface of each second cavity 64. The second terminal fitting 90 is inserted into the second cavity 64 from front. Further, a retainer 66 is mounted into the terminal accommodating portion 62 from below. The second terminal fitting 90 is primarily locked by the second locking lance 65 and further secondarily locked by the retainer 66, thereby being restricted from coming out rearward from the second cavity 64.

The fitting portion 63 has a rectangular tube shape and is open rearward. The tab 91 of each second terminal fitting 90 projects into the fitting portion 63. The second housing 61 is fit into the fitting portion 63 from behind, and the tab 91 of each second terminal fitting 90 is inserted into the box portion 51 of each first terminal fitting 50 and electrically connected.

As shown in FIGS. 2 and 6, an upper wall 69 of the fitting portion 63 is formed with the claw-like lock portion 67. The lock portion 67 projects inwardly of the fitting portion 63 from a lateral central part on a rear end side of the inner surface of the upper wall 69. The lock portion 67 is arranged at a height position to interfere with the lock projection 33 of the lock arm 28 in the process of connecting the first and second connectors 20, 60, and facing and locked to the lock projection 33 from behind when the connection is completed.

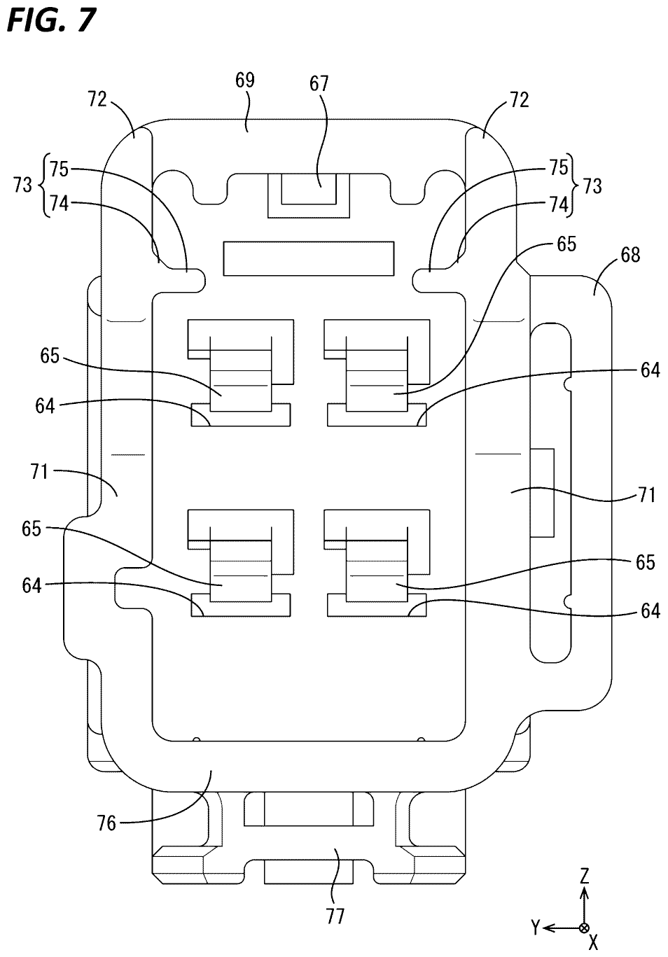

As shown in FIG. 7, a mounting portion 68 bulging outward is formed on a side wall 71 on one side (left side when viewed from front, right side of FIG. 7), out of side walls 71 on both left and right sides of the fitting portion 63. Further, a lower wall 76 of the fitting portion 63 is also formed with a mounting portion 77 shaped differently from the mounting portion 68. The second connector 60 is fixed to an unillustrated vehicle via unillustrated brackets mounted in the mounting portions 68, 77.

As shown in FIG. 6, the second housing 61 includes a pair of left and right wall-like projecting portions 72 projecting rearward from upper parts (upper halves) of the respective side walls 71 on the both left and right sides of the fitting portion 63. Each projecting portion 72 is a vertical wall having wall surfaces facing in the lateral direction, and continuous with each side wall 71 (except the mounting portion 68 in the side wall 71 on the one side) in the lateral direction while having the same thickness. Further, the upper end of each projecting portion 72 is continuous with and at the same height as the upper surface of the upper wall 69 of the fitting portion 63. The lower end of each projecting portion 72 is inclined upward toward a rear side from the fitting portion 63.

The second housing 61 includes the contact portions 73 including rear end parts located behind the fitting portion 63. A pair of left and right contact portions 73 project on the inner surfaces of the respective projecting portions 72 and the respective side walls 71. The respective projecting portions 72 and the respective side walls 71 are arranged on both left and right sides of the contact portions 73 to cover the contact portions 73 from laterally outer sides.

As shown in FIG. 6, the contact portion 73 is in the form of a rib extending in the front-rear direction over the inner surfaces of each side wall 71 and each projecting portion 72, the rear end thereof is connected to the rear end of the side wall 71 and the front end thereof is connected to the rear surface of the terminal accommodating portion 62 (front end of the side wall 71). As shown in FIG. 7, a projecting dimension in the lateral direction of the contact portion 73 is larger than a thickness in the vertical direction of the contact portion 73. The thickness in the vertical direction of the contact portion 73 is larger in a base end part 74 (part coupled to each side wall 71 and each projecting portion 72) than in a tip part 75 (tip part in a projecting direction from the inner surfaces of each side wall 71 and each projecting portion 72). The upper surface of the base end part 74 is inclined downward toward the tip part 75. As shown in FIG. 3, the tip part 75 of the contact portion 73 is located at a height position where the tip part 75 can enter the deflection space 38 for the lock arm 28 in the vertical direction.

### (Functions of Connector 10)

In connecting the first and second connectors 20, 60, the first housing 21 is inserted into the fitting portion 63 of the second housing 61 from front. When the connection of the first and second connectors 20, 60 is started, the respective contact portions 73 are inserted and fit in the respective groove portions 27. The respective contact portions 73 are kept inserted in the respective groove portions 27 from the start of the connection of the first and second connectors 20, 60 to the connection (see FIG. 3).

As the connection of the first and second connectors 20, 60 proceeds, the lock projection 33 of the lock arm 28 interferes with the lock portion 67 of the fitting portion 63 from behind. In this way, the lock arm 28 is resiliently deformed with the front end part 31 as a fulcrum, and the rear end part 34 of the lock arm 38 is displaced downward. If the lock portion 67 rides on the upper surface of the lock projection 33 as shown in FIG. 1 as the connection proceeds, rear end parts of the respective contact portions 73 come out from the respective groove portions 27 and reach the rear surface side of the housing body 22. Accordingly, the respective expanded portions 37 of the rear end part 34 of the resiliently deformed lock arm 28 butt against rear end parts of the tip parts 75 of the respective contact portions 73 from above, and any further downward displacement of the rear end part 34 of the lock arm 28 is suppressed. As a result, the lock arm 28 is substantially supported on both front and rear ends at the front end part 31 and the respective contact portions 73, and a part of the arm body 29 between the lock projection 33 and the rear end part 34 is largely resiliently deformed downward.

Thereafter, the lock portion 67 rides over the lock projection 33 and the lock arm 28 resiliently returns, whereby the lock portion 67 faces to be able to lock the lock projection 33 from behind and the first and second connectors 20, 60 are held in the connected state. The tabs 91 of the second terminal fittings 90 are inserted with a proper depth into the box portions 51 of the first terminal fittings 50 and electrically connected. When the lock arm 28 resiliently returns, the rear end part 34 of the lock arm 28 can obtain reaction forces from the contact portions 73 and can be separated. Thus, a lock feeling when the lock arm 28 resiliently returns can be improved and, for example, a larger connection sound can be generated when the lock arm 28 resiliently returns.

As described above, the connector 10 of this embodiment is provided with the first and second connectors 20, 60 connectable to each other. When the connection direction of the first connector 20 to the second connector 60 is the forward direction and the opposite direction thereof is the rearward direction, the first connector 20 includes the lock arm 28 extending in the front-rear direction and resiliently deformable in the direction intersecting the front-rear direction with the front end part 31 as a fulcrum. The second connector 60 includes the lock portion 67 to be locked to the lock arm 28 and the contact portions 73 located behind the lock portion 67 and configured to contact the rear end part 34 of the lock arm 28 resiliently deformed in the process of connecting the first and second connectors 20, 60 and suppress a displacement of the rear end part 34.

According to the above configuration, in the process of connecting the first and second connectors 20, 60, the contact portions 73 of the second connector 60 contact the rear end part 34 of the lock arm 28 to suppress a displacement of the rear end part 34 of the lock arm 28, whereby the lock arm 28 can be resiliently deformed while being substantially supported on the both ends at the contact portions 73 and the front end part 31. Thus, the lock arm 28 can resiliently return with the reaction force increased and the lock feeling can be improved when the connection of the first and second connectors 20, 60 is completed.

In the process of connecting the first and second connectors 20, 60, the lock arm 28 is cantilevered and resiliently deformed with the front end part 31 as a fulcrum until the contact portions 73 of the second connector 60 contact the rear end part 34 of the lock arm 28, wherefore an increase in the connection resistance of the first connector 20 can be avoided. Further, since the contact portions 73 are formed on the fitting portion 63 of the second connector 60, the size reduction of the first connector 20 can be realized without needing a large design change of the shape on the side of the first connector 20 including the lock arm 28.

Further, in the case of this embodiment, the first connector 20 includes the housing body 22 for accommodating the first terminal fittings 50, the front end part 31 of the lock arm 28 is coupled to the front end side of the housing body 22 and the rear end part 34 of the lock arm 28 is located behind the housing body 22. According to this configuration, the entire length of the lock arm 28 can be made longer as compared to the case where the rear end part 34 of the lock arm 28 is located within the formation range of the housing body 22 in the front-rear direction. Thus, the housing body 22 can be reduced in size. Particularly, since the housing body 22 may not be able to contact the rear end part 34 of the lock arm 28 and it is difficult to form the contact portions 73 in the housing body 22, a merit of forming the contact portions 73 on the fitting portion 63 of the second connector 60 is large.

Further, in the case of this embodiment, the second connector 60 includes the fitting portion 63 to be fit to the housing body 22, and the lock portion 67 is formed on the fitting portion 63. The contact portions 73 are located behind the fitting portion 63, and the second connector 60 includes the wall-like projecting portions 72 projecting rearward from the fitting portion 63 and arranged in pair in the width direction (lateral direction intersecting both the vertical direction, which is a resilient deformation direction of the lock arm 28, and the front-rear direction). The projecting portions 72 arranged in pair are located on both widthwise sides (both left and right sides) of the contact portions 73.

Even if the contact portions 73 project rearward from the fitting portion 63, the contact portions 73 are structured to be hardly interfered with by foreign matters trying to intrude from the both widthwise sides since the projecting portions 72 are located on the both widthwise sides of the contact portions 73. Further, since the contact portions 73 are integrally coupled to the respective projecting portions 72 arranged in pair, the rigidity of the contact portions 73 can be enhanced.

### OTHER EMBODIMENTS OF PRESENT DISCLOSURE

The embodiment disclosed this time should be considered illustrative in all aspects, rather than restrictive.

In the case of the above embodiment, the contact portion is shaped to be integrally coupled to each of the side wall and the projecting portion. In contrast, according to another embodiment, a contact portion may independently project inwardly of the fitting portion from a position away from the side walls and the projecting portions and, in the process of connecting the first and second connectors, the contact portion may be inserted into the through hole in the front end part of the lock arm and a tip side (rear end side) coming out rearward from the through hole may contact the rear end part of the lock arm.

In the case of the above embodiment, the contact portion is in the form of a rib extending long from the side wall to the projecting portion. In contrast, according to another embodiment, a contact portion only has to be arranged at a position capable of contacting the rear end part of the lock arm in the process of connecting the first and second connectors and may, for example, project short in the front-rear direction only on the inner surface of each projecting portion.

In the case of the above embodiment, the front end part of the lock arm is integrally coupled to both the housing body and the respective side portions. In contrast, according to another embodiment, the front end part of the lock arm may be coupled to either the housing body or the respective side portions on the front end side of the housing body.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising a first connector and a second connector connectable to each other,
when a connection direction of the first connector to the second connector is a forward direction and an opposite direction thereof is a rearward direction,
the first connector including a lock arm extending in a front-rear direction, the lock arm being resiliently deformable in a direction intersecting the front-rear direction with a front end part as a fulcrum, and
the second connector including a lock portion to be locked to the lock arm and a contact portion located behind the lock portion for contacting a rear end part of the lock arm resiliently deformed in the process of connecting the first and second connectors and suppressing a displacement of the rear end part in a resilient deformation direction of the lock arm from a contact position.

2. The connector of claim 1, wherein the first connector includes a housing body for accommodating a first terminal fitting, the front end part of the lock arm is coupled to a front end side of the housing body and the rear end part of the lock arm is located behind the housing body.

3. The connector of claim 2, wherein:
the second connector includes a fitting portion to be fit to the housing body,
the lock portion is formed on the fitting portion,
the contact portion is located behind the fitting portion,
the second connector includes wall-like projecting portions projecting rearward from the fitting portion and arranged in pair in a width direction intersecting both the resilient deformation direction of the lock arm and the front-rear direction, and
the projecting portions arranged in pair are located on both sides in the width direction of the contact portion.

4. The connector of claim 3, wherein the contact portion is integrally coupled to each of the projecting portions arranged in pair.
